(19) United States
(12) Patent Application Publication
(10) Pub. No.: US 2025/0348138 A1
(43) Pub. Date: Nov. 13, 2025

(54) METHOD FOR CONSTRUCTING FLUID TRANSITIONS OF A HAND IN A VIRTUAL OR AUGMENTED REALITY ENVIRONMENT

(71) Applicant: Orange, Issy-Les-Moulineaux (FR)

(72) Inventors: Tangui MARCHAND GUERNIOU, Chatillon Cedex (FR); Maxime JOUIN, Chatillon Cedex (FR); Jeremy LACOCHE, Chatillon Cedex (FR)

(21) Appl. No.: 18/872,711

(22) PCT Filed: Jun. 6, 2023
(86) PCT No.: PCT/EP2023/065058

§ 371 Date: Dec. 6, 2024

(30) Foreign Application Priority Data
Jun. 8, 2022 (FR) FR2205489

(51) Int. Cl. G06F 3/01; G06T 11/00

(52) U.S. Cl. CPC G06F 3/013; G06T 11/00

(57) ABSTRACT

A method for generating a graphical representation of a virtual hand is implemented as a function of a first set of parameters representing a first state and a first position of a virtual hand in a virtual environment, and as a function of a second set of parameters representing a geometry and a position of an object intended to be gripped by the hand. The method includes a determination of a fourth set of parameters representing a third state intermediate between the first state and a second state, and a third position between the first position and the second position. The hand grips the object in the first state or the second state. The third state allows generation of a graphical representation of the virtual hand from the first state at the first position to the second state at the second position, passing through the third state at the third position.

### CROSS-REFERENCE TO RELATED APPLICATIONS

This application is filed under 35 U.S.C. § 371 as the U.S. National Phase of Application No. PCT/EP2023/065058 entitled “METHOD FOR CONSTRUCTING FLUID TRANSITIONS OF A HAND IN A VIRTUAL OR AUGMENTED REALITY ENVIRONMENT” and filed Jun. 6, 2023, and which claims priority to FR 2205489 filed Jun. 8, 2022, each of which is incorporated by reference in its entirety.

### BACKGROUND

### Field

The present development relates to the field of virtual reality. More precisely, the development relates to the representation of a virtual hand within a virtual environment.

The user visually has access to this environment via a video feedback (for example by means of a virtual-reality headset).

Hereinafter, the expression “state of a hand” refers to the various configurations that this hand can adopt, i.e. to the relative position of the fingers, of the phalanges and/or of the palm of the hand. For example, such a hand may be in a closed state in which the hand forms a fist, an open state in which the fingers are tensioned in line with the palm, a relaxed state in which the fingers are relaxed, or any intermediate state.

### Description of the Related Technology

Virtual reality (VR) forms a field in which immersion of the user is essential for procuring a satisfactory experience and ergonomics for them. In particular, in many situations in which a user finds themselves in a situation of immersion in a virtual-reality environment, they may be led to control a virtual hand to implement various steps of the type of gripping and moving an object. This control of the virtual hand is for example implemented by means of a controller held by the user.

Control by controller is simple to implement technically, and allows the use of buttons and other haptic devices to enable the system to acquire instructions from the user. Control by controller furthermore makes it possible to offer to the user haptic feedback in the case of interaction of the virtual hand with the environment in which it is immersed.

Control of the virtual hand by a controller is however not without drawback. In particular, when a user holding a controller wishes to grip an object in the virtual environment by means of the virtual hand that they are controlling, the user first of all moves the virtual hand closer to the object. Once the hand is sufficiently close, the user sends an instruction, typically by pressing on a button on the controller, to grip the object. The virtual hand must then implement a transition from a first so-called idle state in which the virtual hand moves in its environment, to a second so-called gripping state in which the hand grips the object.

Implementing this transition from a first neutral state to a second gripping state poses a problem, since either the transition is gradual and starts at the moment of sending the gripping instruction, which causes a latency in implementation thereof, or the transition is instantaneous and this greatly deteriorates the immersion for the user.

The present development sets out to improve the situation.

### SUMMARY

For this purpose, the development proposes a method for generating a graphical representation of a virtual hand in a virtual environment including at least one object at a position, so-called position of said object, said object (120) being intended to be gripped by said virtual hand, the method comprising the following steps:
determination of at least a third state of the virtual hand intermediate between a first state and a second state of the virtual hand, the second state corresponding to a state of the virtual hand gripping the object, so-called gripping state, the third state of the virtual hand being a function of the first state of the virtual hand and second state of the virtual hand,
the third state allowing generation of a graphical representation of the virtual hand from a state of the virtual hand amongst the first state and the second state of the virtual hand to the third state of the virtual hand.

Thus, such a method for generating a graphical representation of a virtual hand offers a fluid transition of the virtual hand from an initial state to a state allowing gripping an object, and this in an anticipated manner, i.e. even before the user produces a gripping instruction by means of a control device triggering gripping of the object by the virtual hand, the virtual hand then being in a gripping state.

More precisely, as the virtual hand approaches the object to be gripped, the hand gradually changes from the first state, or initial state, to the second state, or gripping state, passing through the at least third state, or intermediate state, representing a transition between the initial state and the gripping state. Thus the virtual hand, the movement and actions of which, such as the gripping of an object, can be controlled by a user by means of a control device, such as for example a controller or a joystick, in particular with six degrees of freedom (also denoted “6 DoF”), in particular the control device is located in space, presents to the user a more realistic behavior. The user in particular has no need to give a specific instruction, through the control device, to gradually close the virtual hand when the latter is close to the object, thus simulating the behavior of a “real” hand.

The first state may for example be a state in which the virtual hand is slightly open (a so-called “neutral” or “relaxed” state), completely open (or “flat”), or in a normal state of the virtual hand at the moment when the method is implemented. The second state represents the state in which the actual hand is when it is as close as possible to the object, in a configuration in which the virtual hand is able to grip the object.

The third state of the virtual hand depends on the relative position of the virtual hand with respect to the object as well as on the first state and second state of the virtual hand. The closer the virtual hand is to the object, the closer is this intermediate state to the gripping state. As the virtual hand approaches the object, the intermediate state then becomes more and more similar to the gripping state. In fact, at the moment when the control device issues an instruction to grip the object, the virtual hand grips the latter without abrupt transition or delay in implementing the instruction since it is already in the gripping state or in a state similar to the gripping state. The quality of experience of the user is greatly reinforced, without sacrificing the reactivity of the control of the virtual hand.

According to a particular feature, the generation method is implemented prior to a reception of a gripping instruction by a virtual-reality device reproducing the virtual environment.

According to a particular feature, the generation method includes a verification of the satisfaction of an intention condition relating to gripping of the object by the virtual hand, said satisfaction leading to the determination of the third state of the virtual hand.

According to a particular feature, the generation method includes the determination of the third state of the virtual hand when an intention condition relating to gripping of the object by the virtual hand is satisfied, the third state of the virtual hand being a state of the virtual hand close to the gripping state of the virtual hand, so-called second state of the virtual hand.

According to a particular feature, the satisfaction of the intention condition is verified as a function of at least one parameter of the virtual hand in its current state among the first state and the second state of the hand among the following ones:
a current position of the virtual hand relative to the position of the object;
a current orientation of the virtual hand relative to the position of the object.

According to a particular feature, the method comprises obtaining data representing a direction of the gaze of a user, the satisfaction of the intention parameter associated with an object being a function of gaze data indicating that the user is looking in the direction of said object.

According to a particular feature, the method includes a determination, as a function of a geometry of the object, the second state of the virtual hand in a second position of the virtual hand corresponding to the position of the object.

According to a particular feature, a state of the virtual hand is represented by parameters of a set of parameters.

According to a particular feature, when the first state of the virtual hand is represented by a first set of parameters, the second state of the virtual hand by a third set of parameters, the third state of the virtual hand by a fourth set of parameters and the geometry of the object by a second set of parameters, the method includes a determination, as a function of the first set of parameters and second set of parameters, of a third set of parameters representing the second state of the virtual hand in the second position.

According to a particular feature, the parameters of the third set of parameters represent a second state of the virtual hand when it grips the object.

According to a particular feature, the method includes the generation of the graphical representation of the virtual hand from a state of the virtual hand among the first state and the second state of the virtual hand to the third state.

According to a particular feature, a state of the virtual hand includes a degree of closure of the virtual hand.

According to a particular feature, the third state of the virtual hand includes a degree of closure of the virtual hand whose so-called transition value results from a linear interpolation between the first value of the degree of closure of the virtual hand in a first state and the second value of the degree of closure of the virtual hand in a second state.

In one example, a state of the virtual hand is defined by a plurality of parameters comprising a list of angle values, an angle value describing an angle formed by two successive phalanges of a finger of the virtual hand or an angle formed by a phalanx and the palm of said virtual hand.

In particular, the value of the degree of closure of the virtual hand comprises the list of angle values of the parameters of the state of the virtual hand.

Treating the phalanges individually makes the graphical representation more realistic and more fluid, since these values can be determined finely according to the type of transition required.

According to one example, said at least one fourth set of parameters furthermore comprises a transition parameter the value of which is between a first value, for example a minimum value, corresponding to the first state and to the first position of the virtual hand and a second value, for example a maximum value, corresponding to the second state of the virtual hand and to the second position of the virtual hand corresponding to the position of the object.

In this example, all the fourth sets of parameters form a continuum (or a sufficiently fine discretization) between the initial state and the gripping state. Each state and each position represented by one of the fourth sets of parameters being associated with a value of the transition parameter, the graphical representation of the transition of the virtual hand is thus more realistic and improves immersion. The continuum thus constructed makes it possible to adapt the graphical representation of the virtual hand as a function of the frequency at which frames are displayed by the video feedback giving access to the environment of the virtual hand, for example 90 Hz for virtual reality. Furthermore, this parameterization of all the fourth sets of parameters advantageously makes it possible to adapt the transition of the hand to the speed at which the latter approaches the object.

In one example, at least one angle value is a function of the value of the transition parameter.

Here, defining at least one angle value as a function of a value of the transition parameter makes it possible to finely control the graphical representation of the virtual hand, for example phalanx by phalanx, as a function of the value of the transition parameter.

In one example, the function linking the value of the transition parameter to a given angle value is a linear interpolation passing through an angle value corresponding to the minimum value of the transition parameter and through an angle value corresponding to the maximum value of the transition parameter.

Here the transition data are thus constructed by linear interpolation. The inventors observed that this choice of interpolation was a good compromise between realism and computing speed.

In one example, a value of the transition parameter corresponds to:
at least a ratio between the relative position of the virtual hand with respect to the object and a transition distance when said ratio is positive, and
zero otherwise.

In this example, the value of the transition parameter varies between the values 0 and 1. When the virtual hand is located beyond a certain distance from the object, termed transition distance, the value of the transition parameter is zero, and the hand remains in its normal state (for example a relaxed state). When the virtual hand approaches the object, the value of the transition parameter increases linearly with the proximity of the virtual hand to the object (defining proximity as the difference between the transition distance and the distance between the virtual hand and the object).

According to a particular feature, a state of the virtual hand includes an orientation of the virtual hand (100) relative to the virtual object (120) in the virtual environment. For example, a first set of parameters of the virtual hand in a first state represents an orientation of the virtual hand in the virtual environment.

In one example, the method furthermore comprises:
a determination of the satisfaction, in particular by an intention parameter, of a first condition, said satisfaction giving rise to the determination of said at least one fourth set of parameters and, possibly, of the third set of parameters.

In one example, the method furthermore comprises:
a determination, as a function of the position of the virtual hand, of the orientation of the virtual hand and of the position of the virtual object, of an intention parameter the value of which represents a probability of intention of the user to grip said object with said virtual hand.

Here, the determination of the third set of parameters and of said at least fourth set of parameters is conditioned to the satisfaction of a first condition, referred to as the intention condition, by the intention parameter. This makes it possible to save on computing time, by constructing the third set of parameters and said at least fourth set of parameters only for an object that the user probably intends to grip with the virtual hand.

In one example, the virtual environment comprises a plurality of objects, and the first condition is satisfied for the object associated with said intention parameter having the highest value.

This choice of first condition makes it possible, in a multi-object environment, to compute the transition of the object that the user most probably wishes to grip.

In one example, each object is associated with at least one class, and the value of the second parameter associated with said object is a function of the at least one class associated with the object.

In this example, the objects in the environment are each labelled with a certain class (which may be common to a plurality of objects). These classes may for example correspond to various steps of the process, or to a type of object such as a tool. Thus, when the user must manipulate a plurality of objects (for example tools), these classes contribute to the computation of the second parameter and therefore of the transition of the hand. This makes it possible firstly to better determine the choice of the object serving as a basis for the transition by enabling only the objects relating to a given class, and secondly fulfils a role of mistake-proofing for the user, by encouraging the user to move the virtual hand towards the relevant object or objects.

In one example, the method comprises obtaining data representing a direction of the gaze of a user, the intention parameter associated with an object taking a higher value, the more the gaze data indicate that the user is looking in the direction of said object.

In this example, the determination of the value of the intention parameter is, among other things, a function of the direction of the gaze of the user. The direction of the gaze of the user can for example be obtained by means of a virtual-reality headset. This solution offers to the user a more rapid, ergonomic and intuitive control of the virtual hand by enabling them to control the choice of the object that serves as a basis for constructing the transition of the hand towards a gripping of this object.

In one example, the determination of the intention parameter associated with the object comprises the determination of the presence of the object in a cone starting from the palm of the virtual hand and including a vector orthogonal to the palm.

In this example, the determination of the presence of the object by means of a cone makes it possible to act on the orientation of the virtual hand to determine the value of the intention parameter. This enables a user to select the object that they intend to grip by orienting the virtual hand substantially in the direction of said object. This method makes it possible not to have to compute values for intention parameters associated with objects located outside the cone (or to fix these values at zero as long as the object is located outside the cone, which is equivalent).

In one example, the cone comprises rays forming a mesh of the cone, and the determination of the value of the intention parameter associated with a given object comprises the determination of at least one ray reaching the object, the value of said intention parameter being an increasing function of the collinearity between this ray and the vector orthogonal to the palm.

In this example, the more the virtual hand is oriented in the direction of an object, the higher is the value of the intention parameter associated with said object. This in particular enables a user to select more finely the object on the basis of which the transition can be generated.

In one example, the value of the intention parameter associated with an object is a decreasing function of the distance between the palm and the object.

In this example, the more distant an object, the less is the user deemed to have the intention of gripping it. This allows various optimizations, in particular by declaring the value of the intention parameter associated with an object as being zero when said object is beyond a certain distance of the object. It is thus possible to compute the value of the intention parameter for a large number of objects by very quickly distinguishing the distant objects, for example using techniques resulting from the computation of collisions in a physical motor.

According to a particular feature, the virtual hand is in a first state at a first position in the virtual environment, in a second state at a second position corresponding to the position of the object and in a third state at a third position in the virtual environment.

In this example, the determination of at least one fourth jet of parameters (60) representing at least one third state of the virtual hand (100) intermediate between the first state and a second state of the virtual hand (100), as a function of the first set of parameters (10), a third set of parameters (40) representing the second state of the virtual hand (100) in a second position in the virtual environment, and at least one item of information representing a third position of the virtual hand (100) located between the first position and the second position, the third set of parameters being a function of the first set of parameters (10) and of the second set of parameters (12), the virtual hand gripping the object (120) in one of the states among the first state and the second state in a position respectively among the first position and the second position corresponding to the position of the object, the third state allowing a generation (E8) of a graphical representation of the virtual hand (100) from the first state at the first position to the second state at the second position through the third state at the third position.

Another object of the development is a computer device for implementing a graphical-representation method as described above.

Another object of the development is a computer program product comprising program code instructions for implementing a method according to the development as described previously, when it is executed by a processor.

Such a computer program can be recorded on a recording medium that can be read by a computer. This recording medium may be any entity or device capable of storing the program. For example, the medium can include a storage means, such as a ROM, for example a CD-ROM or a ROM of a microelectronic circuit, or also a magnetic recording means, for example a USB key or a hard disk.

Besides, such a storage medium may be a transmissible medium such as an electrical or optical signal, which can be conveyed via an electrical or optical cable, by radio or by other means, so that the computer program contained therein is remotely executable. In particular, the program according to the development may be downloaded on a network, for example the internet network.

Alternatively, the recording medium may be an integrated circuit in which the program is incorporated, the circuit being adapted to implement or to be used in the implementation of the method that is the aforementioned object of the development.

The development also relates to a virtual-reality device including:
a first generator of a graphical representation of a virtual hand as a function of a set of parameters representing a state of a virtual hand and a position of said virtual hand in a virtual environment,
a second generator of a graphical representation of an object as a function of at least one set of parameters representing a geometry of at least one object intended to be gripped by a virtual hand and a position of said object in said virtual environment,
a graphical reproducer configured to reproduce the virtual environment, the graphical representation generated of the virtual hand, and the graphical representation generated of the object;

wherein the first generator of a graphical representation of a virtual hand includes a computer determining at least a fourth set of parameters representing at least a third state of the virtual hand intermediate between a first state and a second state of the virtual hand, as a function of a first set of parameters, of a third set of parameters representing a second state of the virtual hand in a second position in the virtual environment, and of at least one item of information representing a third position of the virtual hand located between the first position and second position, the third set of parameters being a function of the first set of parameters and second set of parameters, the virtual hand gripping the object in one of the states from the first state and the second state in a position among respectively the first position and the second position corresponding to the position of the object,

the third state allowing the generation of a graphical representation of the virtual hand from the first state at the first position to the second state at the second position, passing through the third state at the third position.

### BRIEF DESCRIPTION OF THE DRAWINGS

Other aims, features and advantages of the development will become apparent upon reading the following description, given simply by way of illustrative and non-limiting example, with reference to the figures, in which:

FIG. 1 shows a simplified diagram of the steps of a control method according to the development,

FIG. 2 shows a virtual hand controlled by the method of FIG. 1,

FIG. 3 shows a simplified diagram of a variant of the method of FIG. 1,

FIG. 4 shows step E4 of FIG. 3,

FIG. 5 shows an example of a device implementing the method of FIG. 1, and

FIG. 6 shows a simplified diagram of a virtual-reality device according to the development.

### DETAILED DESCRIPTION OF CERTAIN ILLUSTRATIVE EMBODIMENTS

### General Principle of the Development

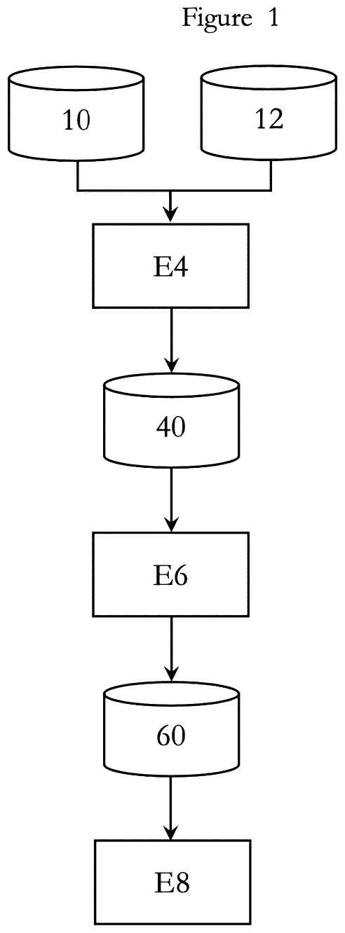

Reference is made to FIG. 1, which shows a method for generating a graphical representation of a virtual hand in a virtual environment.

This method is implemented as a function of a first set of parameters 10 and at least one second set of parameters 12. The first set of parameters 10, also referred to as the set of position parameters, represents a first state of a virtual hand and a first position of said virtual hand in the virtual space. The second set of parameters 12, also referred to as the set of object parameters, represents a geometry (in particular a shape) of at least one object intended to be gripped by said virtual hand and a position of said object in said virtual environment.

The method comprises a step E4 of determining a third set of parameters 40 representing a second state of the virtual hand when it grips the virtual object, a step E6 of determining at least one fourth set of parameters 60 and a step E8 of generating a graphical representation of the virtual hand from the first state at the first position to the second state at the position of the object, passing through the third state at the second position.

The determination step E4 is implemented as a function of the first set of parameters 10 and the second set of parameters 12. The determination step E6 is implemented as a function of the first set of parameters 10, the third set of parameters 12, and at least one item of information representing a second position of the virtual hand in the virtual space located between the first position of the virtual hand and the position of said object. The fourth set of parameters 60 represents at least one third state of the virtual hand intermediate between the first state and the second state.

The first state of the virtual hand, referred to as the initial state, can be the current state of the virtual hand, i.e. the state in which the virtual hand is at the moment of the construction step E6. In another example, the initial state may be a so-called “neutral” state of the virtual hand, corresponding to a state of the virtual hand when it is idle. The neutral state may be a state in which the virtual hand is completely open and flat, or in a variant a so-called relaxed state in which the fingers of the virtual hand are slightly curved. The first set of parameters 10 is termed initial state, for similar reasons.

The second state, called gripping state, corresponds to a state in which the virtual hand grips the object to be seized. The third set of parameters 40, referred to as the set of gripping parameters, represents this state. This third set of parameters 40 is determined from the first set of parameters and from the second set of parameters. Various methods for determining this set of gripping parameters will be described below.

The other sets of parameters 60 (i.e. the fourth set or sets of parameters) representing so-called intermediate states between the initial state and the gripping state are for their part determined by means of the first set of parameters 10 and the third set of parameters 40. These states and sets are termed intermediate since they are “between” the initial state and the gripping state (or “between” the initial set and the gripping set).

Step E8 of generating the graphical representation of the virtual hand is based on the various sets of parameters representing the previously determined intermediate states, as well as on the initial set 10 and on the gripping set 40. The graphical representation thus obtained represents the transition of the hand the various intermediate state or states. This makes it possible to obtain a fluid transition of the virtual hand between its initial state and the gripping state.

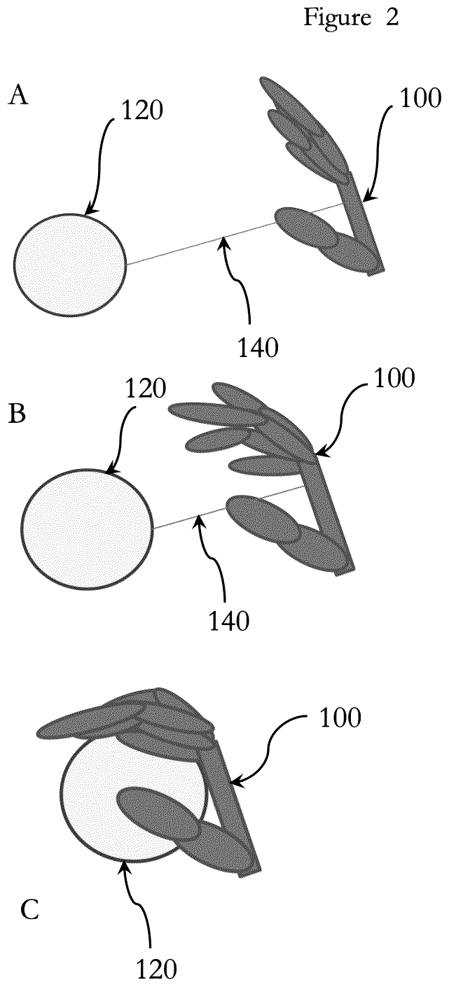

Reference is now made to FIG. 2, which illustrates a virtual hand 100 and an object 120 both located in a virtual environment, the virtual hand 100 seeking to grip the object 120. The virtual hand 100 is controlled via a control device (controller, joystick or any other device adapted to move a virtual hand in a virtual environment). For the remainder of the present description, the control device is here a controller.

The virtual hand 100 is controlled for position and orientation by movement instructions coming from the controller manipulated by a user. The virtual hand 100 is located at a relative position 140 from the object 120, this relative position 140 being able to be derived from the first set of parameters 10 and the second set of parameters 12.

Here the virtual hand 100 is shown in three states, labelled A, B and C on FIG. 2. In state A, the virtual hand 100 is in an initial state (here a relaxed state), at a first position. The virtual hand 100 in state A is therefore at a first distance from the object 100. In state C, the virtual hand 100 is in the gripping state. In this gripping state, the distance separating the virtual hand 100 from the object 120 is less than or equal to a gripping threshold. When the distance separating the virtual hand 100 from the object 120 is less than the gripping threshold, it is considered that the virtual hand 100 is in contact with the surface of the object 120 that it can grip. In state B, the virtual hand 100 is in an intermediate state, and at a relative position 140 intermediate between the relative position of state A and the gripping threshold.

The fact that the virtual hand 100 is in one or other of these states depends on the relative position 140 of the virtual hand 100 with respect to the object 120. The closer the artificial hand 100 is to the object 120 (or the closer the distance between the virtual hand and the object is to the gripping threshold), the closer is an intermediate state of the artificial hand 100 to the gripping state.

The graphical representation of the virtual hand 100 can be produced without instruction from the user other than the movement of the virtual hand 100 controlled via the controller. In particular, the transition of the virtual hand 100 from a normal state to the gripping state does not need to be triggered by an interaction of the user with the controller leading to the issue of an instruction to grip the objects. In fact, the transition of the virtual hand 100 to the gripping state is a function of its movement with respect to the object 120.

The method thus described makes it possible to offer a fluid transition of the virtual hand 100 to the state C of gripping the object 120 in an anticipated manner, even before a gripping instruction is generated by the controller. At the moment when the user wishes to grip the object after having moved the virtual hand 100 closer thereto by means of the controller, the virtual hand 100 is already in a state of being able to grip the object, and an instruction to grip the object 120 can be implemented without latency or abrupt transition.

The virtual hand 100 thus adopts, by means of this method, a behavior that is both reactive, since it is able to grip the object 120 without any latency other than the movement of the virtual hand 100 towards the object 120, and fluid, since it is able to grip the object without abrupt transition.

The general principle described here is of a fluid transition from an initial state (for example the normal state of the hand at its normal position or a relaxed state at a position of the virtual hand without an object in proximity to the virtual hand) to a gripping state. This principle applies just as well for implementing a fluid transition from the gripping state (at the gripping position) to another state of the hand more distant from the object (for example a relaxed state without an object in proximity to the virtual hand), still passing through an intermediate state at an intermediate position.

### Construction of the Fluid Transition

In an example embodiment, the step E6 of determining the transition set or sets comprises the construction of one or more fourth sets of parameters 60 representing intermediate states. A fourth set of parameters 60 representing a given intermediate state comprises a transition parameter t. Such a transition parameter t can take a plurality of values in a given interval.

In general, the transition parameter t can vary between a minimum value and a maximum value. To simplify the remainder of the description, it is considered hereinafter that the transition parameter t varies between 0 and 1 included, naturally other values can be envisaged for the transition parameter t.

Among the set of possible intermediate states for the virtual hand 100, the intermediate state associated with the value 0 of the transition parameter t corresponds for example to the initial state. Similarly, the intermediate state associated with the value 1 of the transition parameter t corresponds for example to the gripping state.

The values of the parameters constituting the sets of parameters representing the various intermediate states of the virtual hand 100 change continuously, in the mathematical sense of the term, with respect to the value of the transmission parameter t. In a particular example, the values of the parameters constituting the sets of parameters representing the various intermediate states change monotonically from the initial state (when the transmission parameter t is equal to 0) to the gripping state (when the transmission parameter t is equal to 1).

In fact, these features contribute to the fluidity of the transition. This is because the values of the parameters constituting the sets of parameters representing the various states vary continuously with the value of the transmission parameter t, provided that the latter itself varies continuously.

This choice is also flexible, since it allows a fine variation in the transition of the virtual hand between its various states. This makes it possible to adapt the speed of this transition to various situations and in particular to the display frequency of the virtual environment on a display device, such as the screen of a virtual-reality headset. For example, the transition can take place at a display frequency of 90 Hz.

In one embodiment, a set of parameters representing a state of the virtual hand comprises a list of angle values, each angle value describing the angle formed by two successive phalanges of a finger of the virtual hand or the angle formed by a phalanx and the palm of said virtual hand.

In this case, the angle value can be a function of the value of the transition parameter t. In a precise example, this function is a monotonic function ranging from a first value of the transition parameter t (that of the initial state) to a second value of the transition parameter t (that of the gripping state).

It is for example possible to express the fact that, for a hand with five fingers, each having no more than three phalanges, for a phalanx p∈[1,3] of a finger n∈[1,5] (n and p being integers), the angle α_(p,n) between the phalanx p and the previous phalanx p−1, or the palm in the case of the first phalanx, is expressed as a function of t, i.e. α_(p,n)(t). The state e(t) of the virtual hand for a value of the transition parameter t can then be expressed as a matrix of dimension 3×5: [symbol] e(t)=(α_(p,n)(t)) [symbol] _(p,n∈[1,3]×[1,5]).

Defining the various states of the virtual hand 100 by angle parameters between phalanges offers a light format for retranscribing the richness of the states that a virtual hand can adopt that is as realistic as possible. This offers great fineness in the representation of the virtual hand 100.

In one example, the function associating a given angle value with a value of the transition parameter is a linear interpolation passing through the angle value of the initial state when the value of the transmission parameter is equal to 0, and through the angle value of the gripping state when the value of the transmission parameter is equal to 1. The interpolation can be linear, which allows very quick computation. The inventors observed that linear interpolation is a good compromise between computing speed and realism. In a variant, the interpolation can be of a different type, for example a quadratic interpolation.

In one example, the virtual hand 100 remains in the neutral state (relaxed or completely flat) as long as it is located at a distance d greater than a transition distance d_T. This transition distance d_T can for example be equal to 30 cm.

In this case, the value of the transition parameter t remains equal to 0 as long as the distance d between the virtual hand 100 and the object 120 is greater than the transition distance d_T. When d<d_T, t varies between 0 a 1 monotonically, and when d≥transition threshold (and therefore when the virtual hand 100 is at its closest to the object 120), t=1. The transition parameter t can vary continuously with respect to the ratio d/d_T, which ensures fluidity in transition. In one example, t=1−d/d_T when d<d_T. The ratio d/d_T represents quantitatively the proximity of the virtual hand 100 to the object 120.

According to one example implementation, the parameters representing a given state for a finger of the virtual hand 100 is determined on the basis of the following

```
Require: P, set of the phalanges of the finger
Require: s, no closure
i←0
for each: p∈P
  while i≤1 & !p.stable do
    InterpolationClosure(i)
    if TestCollision then
      p.parent.StabilizeRecursively( )
      p.stable ← true
    end if
    i←i+s
  end while
```

wherein:
   InterpolationClosure (value) is a function of linear interpolation between the initial state (InterpolationClosure(0)) and the gripping state (InterpolationClosure(1)) as described above,
   StabilizeRecursively determines stoppage of all the anterior phalanges in a given finger,
   & is the AND logic operator, and ! the negation logic operator.

### Intention to Grip

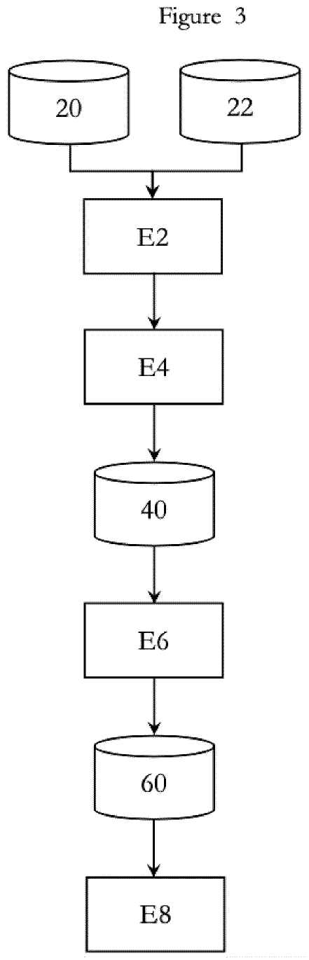

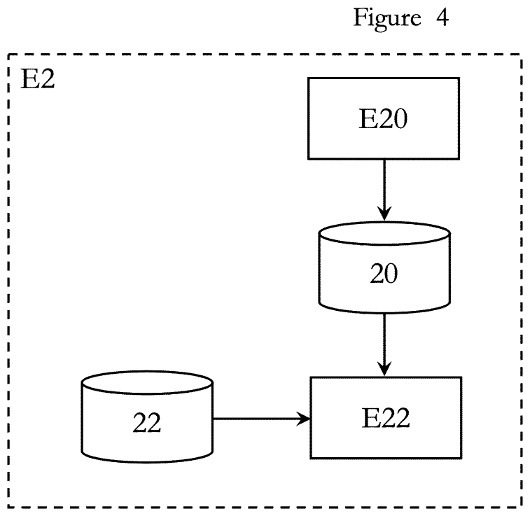

Reference is now made to FIGS. 3 and 4, which describe an alternative example implementation of the method described in FIG. 1. In this example, the method shown in FIG. 3 comprises a step E2 of determining an intention of the user to grip the object 120 with the virtual hand 100 that they are controlling.

When the virtual environment in which the virtual hand 100 is moving comprises a plurality of objects, the method in this example makes it possible to determine for which object among the plurality of objects included in the virtual environment to construct the third set of parameters 40 and the fourth set of parameters 60. To do this, the method implements, prior to the step E4 of determining the third set of parameters 40, a step E2 of determining, for a given object, an intention parameter 20 representing the intention of the user to grip said object. This step, like the transition of the virtual hand 100 described above, is implemented without needing a specific instruction from the user. This improves the immersion of the latter in the virtual environment.

The determination step E2 comprises a step E20 of determining an intention parameter 20 associated with the object 120 and a step E22 of determining the satisfaction of an intention condition 22 on the basis of this intention parameter 20.

The step E20 is implemented as a function of the first set of parameters 10 and the second set of parameters 12. In fact, a value of the intention parameter 20 determined in step E20 is associated with the object 120 relating to the second set of parameters 12. The value of the intention parameter 20 represents a probability of intention of the user to grip said object 120 with said virtual hand 100. Various methods for determining this value of the intention parameter 20 will be described below.

Step E22 determines the satisfaction, by the values of the intention parameters 20 associated with the object 120 that were previously determined, of an intention condition 22. When the intention condition 22 is satisfied, this triggers the step E6 of determining the third set of parameters 20 described above as a function of the first of parameters 10 and the second set of parameters 12 the intention data 20 of which satisfy the intention condition 22.

Apart from being able to distinguish the objects from each other and to determine therefrom one that can serve as a basis for the transition, this step E2 of determining intention makes it possible to save on computing time, for example by automatically eliminating a virtual object 120 for which the value of the intention parameter would be too small (for example since it is too far away from the virtual hand 100).

The value of the intention parameter represents a probability, as explained above. Thus, as a function of one example embodiment, the value of the parameter is for example between 0 a 1 inclusive. When the value of the intention parameter of an object is equal to 0, the user probably does not intend to grip this object, and when the value of the intention parameter is equal to 1, the user very likely does intend to grip this object.

According to one example embodiment, when a plurality of objects are present, the intention condition 22 for an intention parameter associated with a given object 120 is the fact of having the highest intention value among all the intention parameters 20.

According to another example of implementation, at least one class is associated with at least one object (and for example with all the objects). The classes that can be associated with an object form a set of classes. The value of the intention parameter is then here a function of this at least one class. More precisely, at the moment of the step E2 of determining intention, it is determined whether the class associated with the object belongs to a subset of classes of all the classes. If such is the case, the determination of the intention parameter 20 continues, otherwise the intention condition 22 is considered to be not satisfied (or alternatively the intention parameter is declared to be zero). In the case where a plurality of classes are associated with an object, the intention condition may be that at least one of these classes belongs to the subset of classes.

It should be noted that, although the at least one class is associated with the object, a plurality of objects can share the same class, and this even if the objects are of different natures.

This example of implementation is particularly advantageous in an example of a situation where a user must implement a certain process divided by task, each task involving one or more objects (for example one or more tools). Here each class relates to a given task of the process. Each tool is used in one or more tasks of the process. Each tool is then associated with the class or classes relating to the tasks in which the tool can be used. When the user is at a given task, the method comprises presupposing that the user does not have the intention of gripping an object other than the one or ones used in said given task. The objects that do not relate to this task therefore have their intention parameter declared zero as long as the current task (in which they are not being used) has not finished. This serves both for saving on computing time, but also can fulfil the role of mistake-proofing for a user, by encouraging them not to go towards an object the transition of which is not computed (the hand therefore not making a transition towards the gripping of this object). Guidance of the user is improved, without this impairing immersion compared for example with a highlighted display of the objects.

This example embodiment also makes it possible to be able to prevent the gripping of certain objects (for example if they are not intended to be gripped), and therefore to not construct a fluid transition towards these objects.

According to an example embodiment, the intention to grip a given object can also depend on a direction of the gaze of the user. More precisely, the method comprises acquiring data relating to the direction of the gaze of the user. The value of the intention parameter 20 is then a function of these data relating to the direction of gaze. For example, if the data relating to the direction of gaze indicate that the user is looking in the direction of the object 120, then the value of the intention parameter 20 is close to 1. The step of determining the value of the intention parameter 20 can here comprise the determination of a distance between the direction of the gaze of the use and the object, and then the determination of a gaze factor that is a decreasing function of said distance between the gaze and the object. The gaze factor can then be integrated in the calculation of the value of the intention parameter, for example by multiplying the value of the intention parameter by the gaze factor.

To avoid forcing the user to look continuously at the object 120, the gaze factor can be determined at regular intervals, for example every ten frames, or every second. These examples are given by way of illustration.

According to one example embodiment, the determination of the intention parameter associated with the object comprises the determination of the presence of the object in a cone the vertex of which is located at the palm of the virtual hand and including a vector orthogonal to the palm. The cone can for example start from the center of the palm, although it can start from another point on the palm.

This determination of the intention by including the object in a cone makes it possible to act on the orientation of the virtual hand 100 to determine the value of the intention parameter. In particular, by judiciously orienting the virtual hand 100, the user is deemed not to have the intention to grip the objects located outside the cone. The vector orthogonal to the palm (also called the normal to the palm) is preferably inside the cone, for example substantially at the center of the cone (but not necessarily).

The methods for determining the value of the intention parameter by class associated with an object, by means of the direction of the gaze and by the presence of the object in a cone, are complementary and can be combined with each other.

According to one example, rays forming a mesh of the cone are defined. Determining the value of the intention parameter associated with a given object then comprises determining at least one ray reaching the surface of the object. The value of the intention parameter is determined as an increasing function of the collinearity between this ray and the vector orthogonal to the palm. The collinearity can for example be calculated as the scalar product of the unitary vector defining the direction of the ray and the normal to the palm (also unitary, i.e. with a norm equal to 1).

According to one example, the value of the intention parameter 20 associated with an object 120 is a decreasing function of the distance between the palm of the virtual hand 100 and the object 120.

This decreasing function can have a threshold beyond which the value of the intention parameter is zero. This makes it possible to very quickly exclude distant objects where it is reasonably sure that the user does not intend to grip them in the short term.

According to one example implementation, a belonging to the cone previously described for the virtual hand 100 is determined on the basis of the following

```
Require: minAngleX
Require: maxAngleX
Require: minAngleZ
Require: maxAngleZ
Require: nbRaysX
Require: nbRaysZ
Require: palmForward
Require: reach
xAngle←0
yAngle←0
For i=0;i<nbRaysX;i+=1 do
  xAngle ← minAngleX + i×(maxAngleX − minAngleX)/nbRaysX
  for j=0;j<nbRaysZ;j+=1 do
    zAngle ← minAngleZ + j×(maxAngleZ − minAngleZ)/nbRaysZ
    rayRotation ← ComputeRotation(xAngle,zAngle)
    rayDirection ← palmForward*rayRotation
    if RayCast(rayDirection,reach,hitDist,hitPoint) then
      hitDist←hitDist/5+hitDist×4/5×rayDirection•palmForward
      if hitDist < minDist then
        minDist ← hitDist
        contactPoint ← hitPoint
      end if
    end if
  end for
end for
```

where minAngleX, maxAngleX, minAngleZ and maxAngleZ are the lower and upper bounds of the cone with respect to the directions X and Z (respectively); nbRaysX and nbRaysZ are the number of rays forming the mesh in the directions X and Z (respectively); palmForward the normal to the palm and reach the maximum distance that a ray can reach. The bounds along X and Z and the normal to the palm define together the cone and the variables nbRaysX and nbRaysZ define the density of its mesh.

Each ray has a distance of intersection with the object hitDist and a point of intersection with the object hitPoint. hitDist and hitPoint are derived among other things from the variable reach. This algorithm makes it possible to identify all the rays encountering the object. In this set of rays, the algorithm extracts therefrom the ray having the smallest impact distance hitDist.

In order to favor the rays closest to the normal to the palm (and to limit the problems of distinguishing between objects), the distances hitDist obtained can be weighted by the collinearity between the direction vector of each ray and the normal to the palm so as to obtain a weighted distance DistPond, for example as below (where DistPond is a linear combination of the distance hitDist and of a weighting of the distance by the collinearity between the direction of the ray rayDirection and the normal to the palm palmForward). Here the factors ⅕ and ⅘ are selected arbitrarily, it will be possible to envisage other pairs of weighting factors.

$$DistPond = hitDist / 5 + hitDist \times 4 / 5 \times rayDirection \cdot palmForward$$

Then the ray that has the smallest weighted distance is kept as the “intentional” point of contact with the object. This intentional point of contact can serve as a basis for determining the state of gripping at the step E4 of determining the third set of parameters 40.

When the determination of the values of the intention parameters is also based on the direction of the gaze and/or a class associated with the object, it is possible to use data relating to the direction of the gaze or the correspondence between a class associated with the object to automatically eliminate the objects that do not satisfy conditions relating to the direction of the gaze and/or to the class of object. This makes it possible to not have to take into account these objects for the computations of intersection of rays, reducing the computation time necessary.

The various examples of step E2 of determining intention can be implemented in the case where a single virtual object 120 is present in the virtual environment. This makes it possible to determine the gripping set 40 and the intermediate set 60 only when the value of the intention parameter 20 is sufficient, for example when the virtual hand 100 is in proximity to the virtual object 120. This saves on computing time.

### Construction of the Gripping State

At the step E4 of determining the third set of parameters 40, the gripping state is constructed. This gripping state can be constructed from the determination of a ray starting from the palm and intersecting the surface of the object. This ray may for example be the ray determined at the step E4 of determining the values of the intention parameters, and be the ray having the smallest weighted distance. This ray may alternatively be computed at step E6, in particular when the method does not comprise the step E4 of determining the values of the intention parameters.

From this ray thus determined, a projection is simulated of the virtual hand in the direction of said ray and with the palm of the projection of the virtual hand 100 in contact with the object 120. Once this projection has been made, and therefore the projection of the virtual hand 100 in contact with the object 120, the fingers of the projection are closed on the object. Once the phalanges of all the fingers have been closed to the maximum, the angles of the phalanges with their neighbors and/or the palm define together the values of the parameters representing the gripping state. This construction of the values of the parameters representing the gripping state can comprise a step of verifying the absence of interpenetration between the object and the virtual hand. This verification of the absence of interpenetration can be implemented at each iteration of the closure of the phalanges.

### Frequency of Implementation of the Steps

A method has been described allowing a graphical representation of a virtual hand as a function of a first set of parameters (relating to an initial state and an initial position of a virtual hand) and of at least one second set of parameters (relating to an object). This method comprises, as described above:
E2 (optional) the determination of an intention to grip the virtual object 120 by the virtual hand 100
E4 the determination of a third set of parameters 40,
E6 the determination of at least one fourth set of parameters 60 as a function of this third set of parameters, and
E8 the generation of the graphical representation of the virtual hand from the first state at the first position (of the first set of parameters) to the second state at the position of the object (of the third set of parameters) passing through the third state at the second position (of the fourth set of parameters).

These steps E2 to E8 can be implemented when each image of the graphical representation of the virtual hand is generated. For example, for a virtual hand of the type consisting of a virtual hand in virtual reality, the frequency of the graphical representation can be 90 Hz.

In one example embodiment, the steps are not implemented at each generation of an image. Some steps can be implemented every n images (for example every 10 images).

As a function of one example embodiment, steps E4 and E6 (and optionally step E2 when it forms part of the method) are implemented every n images (with n>2). In fact, during the n−1 images where steps E4 and E6 (and optionally step E2) are not implemented, the last gripping set 40 and the last intermediate set or sets 60 determined are used. This advantageously makes it possible not to recompute the gripping set 40 and the intermediate set or sets at all the images, which accordingly reduces the computing time for implementing this method, without excessively sacrificing in realism as long as the virtual hand 100 and/or the objects 120 do not move too quickly. When the method includes step E2, the frequency thereof can be identical to that of steps E4 and E6, or different. According to one example, the gripping set 40 is determined every ten images, and the intermediate set or sets 60 are also determined every ten images (on the basis of the gripping set 40 and the first set 10).

### Device

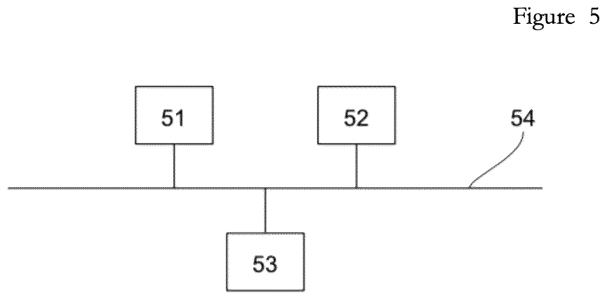

FIG. 5 shows a device able to implement the graphical representation method as a function of FIG. 1.

Such a device can comprise at least one hardware processor 51, a storage unit 52, and at least one network interface 53 that are connected together through a bus 54. Naturally, the elements constituting the device can be connected by means of a connection other than a bus.

The processor 51 controls the steps of the method. The storage unit 52 stores at least one program for implementing the method according to one embodiment of the development to be executed by the processor 51, and various data, such as sets of parameters used for computations made by the processor 51, intermediate data of computations made by the processor 51, etc. The processor 51 can be formed by any known suitable hardware or software, or by a combination of hardware and software. For example, the processor 51 can be formed by dedicated hardware such as a processing circuit, or by a programmable processing unit such as a central processing unit that executes a program stored in a memory thereof.

The storage unit 52 can be formed by any suitable means capable of storing the program or programs and data in a manner that can be read by a computer. Examples of storage unit 52 comprise non-transient storage media that can be read by computer such as semiconductor memory devices, and magnetic, optical or magnetooptical recording media loaded in a read and write unit.

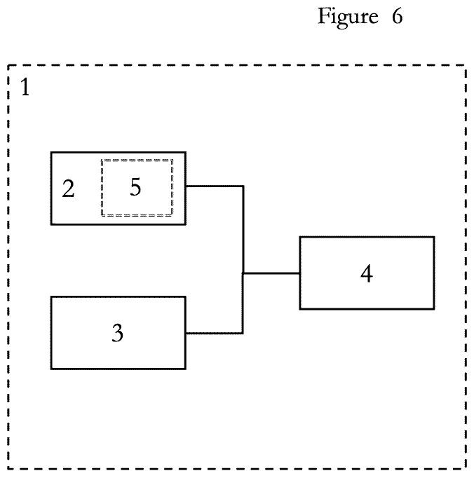

Reference is made to FIG. 6, which shows an example of architecture of a virtual-reality device according to one aspect of the development. The virtual-reality device 1 comprises a first generator 2 of a graphical representation of the virtual hand 100, a second generator 3 of a graphical representation of the object 120, and a graphical reproducer 4. These three elements can communicate with each other.

The first generator 2 is able to implement a graphical representation of a virtual hand 100 as a function of a set of parameters (for example the first, third or fourth set of parameters described above) representing the state of the virtual hand 100 and a position of said virtual hand 100 in its virtual environment.

The second generator 3 is able to implement a graphical representation of the object 120 as a function of at least one set of parameters (for example the aforementioned second set of parameters 12) representing a geometry of at least one object 120 intended to be gripped by the virtual hand 100 and a position of said object 120 in said virtual environment.

The graphical reproducer 4 is configured to reproduce the virtual environment, the graphical representation generated of the virtual hand 100, and the graphical representation generated of the object 120.

The first graphical-representation generator 2 includes a computer 5 determining at least a fourth set of parameters 60 representing at least a third state of the virtual hand 100 intermediate between a first state and a second state of the virtual hand 100, as a function of a first set of parameters 10, of a third set of parameters 40 representing a second state of the virtual hand 100 in a second position in the virtual environment, and of at least one item of information representing a third position of the virtual hand 100 located between the first position and a second position, the third set of parameters being a function of the first set of parameters 10 and of the second set of parameters 12, the virtual hand gripping the object 120 in one of the states from the first state and the second state in a position among respectively the first position and the second position corresponding to the position of the object.

The third state makes it possible to implement a generation of a graphical representation of the virtual hand 100 from the first state at the first position to the second state at the second position, passing through the third state at the third position (such as the generation implemented in the aforementioned step E8).

The virtual-reality device 1 can comprise the hardware components shown in FIG. 5 and described above in relation to this FIG. 5.

1. A method of generating a graphical representation of a virtual hand in a virtual environment including at least one object at a position, so-called position of the object, the object being intended to be gripped by the virtual hand, the method comprising:
a determination of at least a third state of the virtual hand intermediate between a first state and a second state of the virtual hand, the second state corresponding to a state of the hand gripping the object, so-called gripping state, the third state of the virtual hand being a function of the first state and of the virtual hand, and of the second state of the virtual hand,
the third state allowing generation of a graphical representation of the virtual hand from a state of the virtual hand among the first state and the second state of the virtual hand to the third state of the virtual hand.

2. The method according to claim 1, wherein the method includes a determination, as a function of a geometry of object, of the second state of the virtual hand in a second position of the virtual hand corresponding to the position of the object.

3. The method according to claim 1, wherein a state of the virtual hand is represented by parameters of a third set of parameters.

4. The method according to claim 1, wherein the method includes the generation of the graphical representation of the virtual hand from a state of the virtual hand among the first state and the second state of the virtual hand to the third state.

5. The method according to claim 1, wherein a state of the virtual hand includes a degree of closure of the virtual hand.

6. (canceled)

7. (canceled)

8. (canceled)

9. (canceled)

10. (canceled)

11. (canceled)

12. (canceled)

13. A computer device for implementing the graphical-representation method according to claim 1.

14. A processing circuit comprising a processor and a memory, the memory storing program code instructions of a computer program to execute the control method according to claim 1, when the computer program is executed by the processor.

15. A virtual-reality device including:
a first generator of a graphical representation of a virtual hand in a state of the virtual hand in a virtual environment,
a second generator of a graphical representation of an object intended to be gripped by a virtual hand at a position of the object in the virtual environment, and
a graphical reproducer configured to reproduce the virtual environment, the graphical representation generated of the virtual hand, and the graphical representation generated of the object;
wherein the first generator of a graphical representation of a virtual hand includes a computer determining at least a third state of the virtual hand intermediate between a first state and a second state of the virtual hand, the second state corresponding to a state of the hand gripping the object, so-called gripping state, the third state of the virtual hand being a function of the first state of the virtual hand and second state of the virtual hand,
the third state allowing generation of a graphical representation of the virtual hand from a state of the virtual hand among a first state and a second state of the virtual hand to the second state at the second position, passing through the third state at the third position.

16. The method according to claim 1, wherein the generation method is implemented prior to a reception of a gripping instruction by a virtual-reality device reproducing the virtual environment.

17. The method according to claim 1, wherein the generation method includes a verification of the satisfaction of an intention condition relating to gripping of the object by the virtual hand, the satisfaction leading to the determination of the third state of the virtual hand.

18. The method according to claim 17, wherein the satisfaction of the intention condition is verified as a function of at least one parameter of the virtual hand in its current state among the first state and the second state of the hand among the following ones:
a current position of the virtual hand relative to the position of the object,
a current orientation of the virtual hand relative to the position of the object.

19. The method according to claim 17, wherein the method comprises obtaining data representing a direction of the gaze of a user, the satisfaction of the intention parameter associated with an object being a function of gaze data indicating that the user is looking in the direction of the object.

20. The method according to claim 4, wherein the third state of the virtual hand includes a degree of closure of the virtual hand whose so-called transition value results from a linear interpolation between the first value of the degree of closure of the virtual hand in a first state and the second value of the degree of closure of the virtual hand in a second state.

21. The method according to claim 1, wherein the virtual hand is in a first state at a first position in the virtual environment, in a second state at a second position corresponding to the position of the object and in a third state at a third position in the virtual environment.

22. The method according to claim 1, wherein a state of the virtual hand includes an orientation of the virtual hand relative to the virtual object in the virtual environment.
